(19) United States
(12) Patent Application Publication
(10) Pub. No.: US 2010/0225891 A1
(43) Pub. Date: Sep. 9, 2010

(54) ILLUMINATION OPTICAL SYSTEM AND EXPOSURE APPARATUS

(75) Inventor: Shunsuke Ota, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/716,377

(22) Filed: Mar. 3, 2010

(30) Foreign Application Priority Data
Mar. 3, 2009 (JP) 2009-049305

(51) Int. Cl. G03B 27/54; G03B 27/32

(52) U.S. Cl. 355/67; 355/77

(57) ABSTRACT

An illumination optical system includes a barrel configured to house a lens having an optical axis that extends in a direction perpendicular to a gravity direction, wherein the barrel includes an inner surface that has a pair of projections each contacting an outer circumference surface of the lens, and wherein on a plane perpendicular to the optical axis, when viewed from an intersection between the optical axis and the plane perpendicular to the optical axis, an absolute value of an angular range in which each projection contacts the outer circumference surface of the lens is from 5° to 40° with respect to an axis that passes the intersection and is parallel to the gravity direction.

### BACKGROUND OF THE INVENTION

1. Field of the Invention

The present invention relates to an illumination optical system and an exposure apparatus.

2. Description of the Related Art

In a projection exposure apparatus, a projection optical system may partially include a barrel configured to vertically place a lens so that an optical axis of the lens can be perpendicular to the gravity direction. Prior art includes Japanese Patent Application No. (“JP”) 11-231192.

A vertical placement structure of a lens is proposed for the projection optical system (as in JP 11-231192), but no vertical placement structure is proposed for an illumination optical system. Consequently, such an illumination optical system cannot properly reduce the influence of the stress birefringence on the lens, and a desired polarization state may change particularly in the exposure apparatus that utilizes a polarization illumination under the influence of the stress birefringence.

### SUMMARY OF THE INVENTION

The present invention provides an illumination optical system and an exposure apparatus, which can reduce the influence of the stress birefringence that may occur in a lens.

An illumination optical system configured to illuminate a surface includes a barrel configured to house a lens having an optical axis that extends in a direction perpendicular to a gravity direction. The barrel includes an inner surface that has a pair of projections each contacting an outer circumference surface of the lens. On a plane perpendicular to the optical axis, when viewed from an intersection between the optical axis and the plane perpendicular to the optical axis, an absolute value of an angular range in which each projection contacts the outer circumference surface of the lens is from 5° to 40° with respect to an axis that passes the intersection and is parallel to the gravity direction.

Further detailed objects and other characteristics of the present invention will become apparent by the preferred embodiments described below referring to accompanying drawings which follow.

### BRIEF DESCRIPTION OF THE DRAWINGS

FIG. 1 is a sectional view of a barrel of an illumination optical system according to this embodiment.

FIG. 2 is a sectional view taken along a Z-axis in FIG. 1.

FIG. 3 is an optical path diagram of an exposure apparatus that can apply the barrel shown in FIG. 1.

### DESCRIPTION OF THE EMBODIMENTS

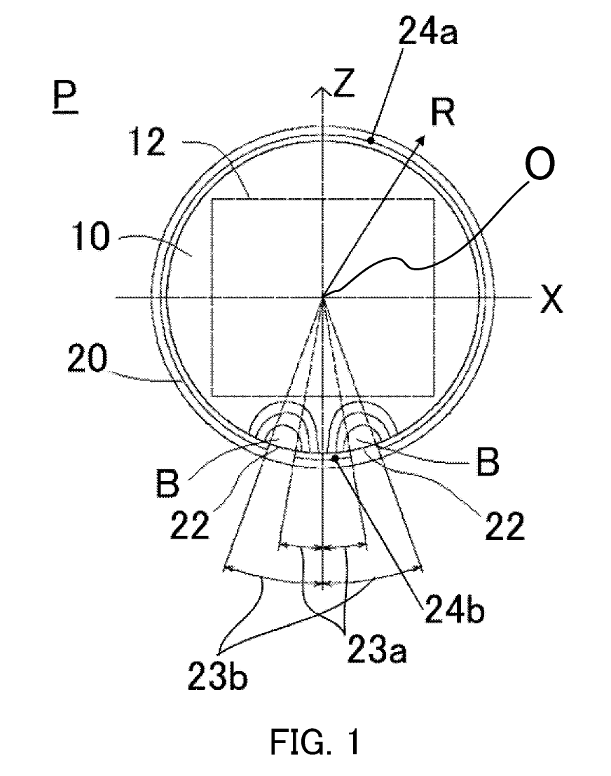

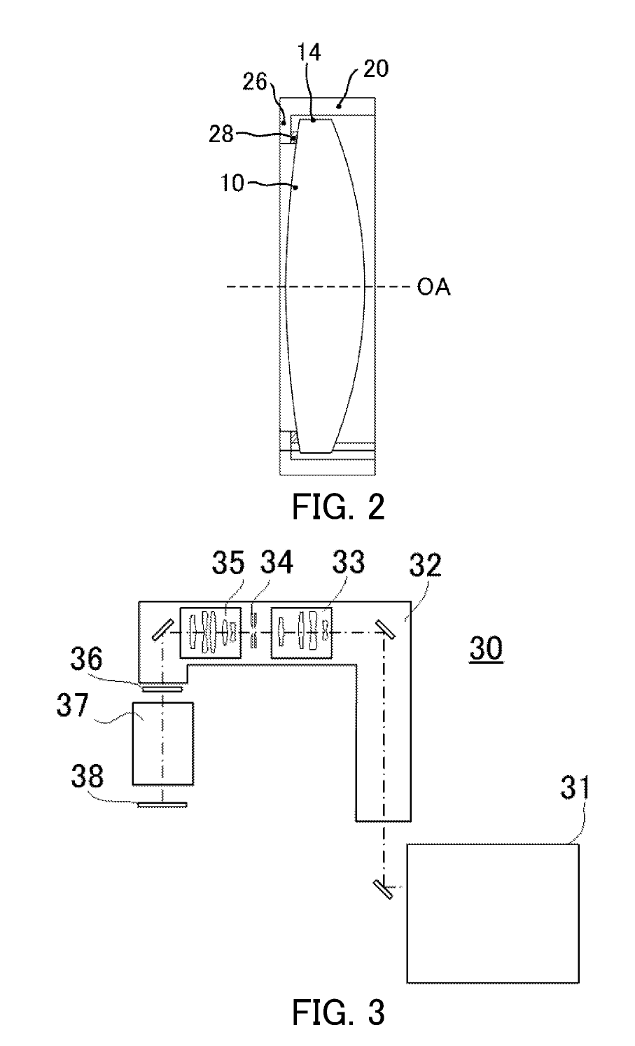

FIG. 1 is a sectional view on a (paper) plane perpendicular to an optical axis of a lens 10 in a barrel 20 configured to house the lens 10 of an illumination optical system according to this embodiment. FIG. 2 is a sectional view taken along a Z-axis in FIG. 1 and “OA” represents the optical axis of the lens 10.

An XZ coordinate system is set as shown in FIG. 1. The X-axis and the Z-axis are orthogonal to each other. An origin O is an intersection between the optical axis of the lens 10 and the paper plane, and corresponds to a center of the lens 10 on the paper plane. The X-axis is a line that passes the origin O and longitudinally halves a circle that is an outline of the lens 10. The Z-axis is a lens centerline that passes the origin O and laterally halves the circle that is the outline of the lens 10 on the plane P. The Z-axis is an axis parallel to the gravity direction, and its downward direction of the Z axis accords with the gravity direction.

The lens 10 is arranged so that its optical axis perpendicular to the paper plane can pass the origin O and extend in a direction perpendicular to the gravity direction that is the downward direction of the Z-axis. The lens 10 has a rectangular (including a square and a rectangle having round corners) or elliptic passage range 12 of effective light. It is important for the lens 10 to reduce the influence of the stress birefringence generated by vertical placement support on the passage range 12 of the effective light. The lens 10 of this embodiment is a biconvex lens as shown in FIG. 2, but a kind of the lens 10 is not limited.

The barrel 20 has an inner surface that holds an outer circumference surface 14 of the lens 10 and a fall preventive unit configured to prevent a fall of the lens 10. The following description assumes that the barrel 20 is so cylindrical that its inner surface has an approximately circular shape on a section perpendicular to the optical axis, and the inner surface of the barrel 20 is an inner circumference surface.

The inner circumference surface of the barrel 20 includes a pair of projections 22 each contacting the outer circumference surface 14 of the lens 10, and a pair of retractors 24a or 24b that retract to the outside of the radial direction of the lens 10 (or the R direction shown in FIG. 1) from the pair of projections 22. The inner circumference surface of the barrel 20 can be manufactured by surface-treating (such as cutting) an inner circumference surface having a cylindrical surface. The retractor 24a is formed on the upper side of the pair of projections 20 and the retractor 24b is formed on the lower side of the pair of projection 20.

The barrel 20 contacts the outer circumference surface 14 of the lens 10 only through the pair of projections 22 of its inner circumference surface. Next, each projection 22 contacts the outer circumference surface 14 of the lens 10. The projection 22 of this embodiment can be easily manufactured by cutting parts corresponding to the retractor 24a and 24b of the cylindrical surface.

“B” in FIG. 1 schematically shows an influential range of the stress birefringence in the lens 10 as a result of that each projection 22 supports the outer circumference surface 14 of the lens 10. It is necessary to set a position of each projection 22 so that the influential range B of the stress birefringence cannot reach the passage range 12 of the effective light.

Accordingly, this embodiment sets an absolute value of an angular range (23a to 23b in FIG. 1) in which each projection 22 can contact the outer circumference surface 14 of the lens 10 when viewed from the origin O on the paper plane of FIG. 1 to a value from 5° to 40° with reference to the Z-axis. If this value is less than 5°, the outer circumference surface 14 of the lens 10 is supported around the intersection between the Z-axis and the inner circumference surface of the barrel 20, and the stress birefringence piles, increases, and reaches the passage range 12 of the effective light. The passage range 12 of the effective light of the lens 10 usually has a shape of a rectangle close to a square, as shown in FIG. 1. The passage range 12 of the effective light extends to the outside in the radial direction (R direction) at around ±45° to the Z-axis when viewed from the origin O. A stress birefringence amount by each projection 22 is likely to increase in the radial direction. Therefore, this embodiment limits the largest installation angle of each projection 22 to 40° or less so as to prevent the influential range B of the stress birefringence from reaching the passage range 12 of the effective light.

The pair of projections 22 are symmetrically arranged with respect to the Z-axis for description purposes in FIG. 1, but may be asymmetrically arranged. For example, one projection 22 may be held at an angular range from 5° to 10° and the other projection 22 may be held at an angular range from 10° to 15°. This flexible arrangement of the projections 22 is advantageous, for example, when the passage range 12 of the effective light is asymmetrical with respect to the Z-axis, when it is necessary to prevent the interference with another element, or when the manufacture is facilitated without requiring a strict symmetry.

The fall preventive unit is an adhesive 28 applied to a backside of a front plate 26 of the barrel 20 and configured to bond the end of the surface of the lens 10, but this configuration is illustrative purposes only. For example, the fall preventive unit may use a spring element (not shown) configured to force the back surface of the lens 10 against the underside of the front plate 26 of the barrel 20, or may use another structure.

The barrel 20 of this embodiment can be applied to a part configured to support the lens 10 through a vertical placement in an illumination optical system in an exposure apparatus. Referring now to FIG. 3, a description will be given of an exposure apparatus 30 that uses the barrel 20 for a part of the illumination optics system. FIG. 3 is an optical path diagram of the exposure apparatus 30.

Light from a light source 31 is adjusted to a desired state including its polarization state by an illumination optical system 32 and a pattern of an original (a mask or a reticle) 36 is exposed onto a substrate (a wafer or a glass plate) 38 via a projection optical system 37.

The illumination optical system 32 is an optical system configured to illuminate the original 36 arranged at a surface to be illuminated, and includes a polarization state controller (not shown), a movable blind 34, and a plurality of barrels 33 and 35. The movable blind 34 defines the passage range of the effective light and controls the irradiation range onto the original 36. The barrels 33 and 35 are barrels configured to house one or more lens, and can apply the lens supporting structure of the barrel 20. Using the barrel 20, the influence of the stress birefringence can be reduced, the polarization state of the light set by the polarization state controller (not shown) can be maintained, and the original 36 can be illuminated by the desired polarization state. As a result, the exposure apparatus 30 can expose the original pattern to the substrate 38 with high resolution.

The device manufacturing method includes the step of exposing the photosensitive agent applied substrate using the above exposure apparatus, the step of developing the substrate, and other well-known steps. The device includes a semiconductor integrated circuit device and a liquid crystal display device, etc.

This application claims the benefit of Japanese Patent Application No. 2009-049305, filed Mar. 3, 2009, which is hereby incorporated by reference herein in its entirety.

What is claimed is:

1. An illumination optical system configured to illuminate a surface, the illumination optical system comprising a barrel configured to house a lens having an optical axis that extends in a direction perpendicular to a gravity direction,
wherein the barrel includes an inner surface that has a pair of projections each contacting an outer circumference surface of the lens, and
wherein on a plane perpendicular to the optical axis, when viewed from an intersection between the optical axis and the plane perpendicular to the optical axis, an absolute value of an angular range in which each projection contacts the outer circumference surface of the lens is from 5° to 40° with respect to an axis that passes the intersection and is parallel to the gravity direction.

2. The illumination optical system according to claim 1, wherein the pair of projections are asymmetrically arranged with respect to the axis that passes the intersection and is parallel to the gravity direction.

3. An exposure apparatus comprising an illumination optical system that includes a barrel configured to house a lens having an optical axis that extends in a direction perpendicular to a gravity direction,
wherein the barrel includes an inner surface that has a pair of projections each contacting an outer circumference surface of the lens, and
wherein on a plane perpendicular to the optical axis, when viewed from an intersection between the optical axis and the plane perpendicular to the optical axis, an absolute value of an angular range in which each projection contacts the outer circumference surface of the lens is from 5° to 40° with respect to an axis that passes the intersection and is parallel to the gravity direction.

4. A device manufacturing method comprising the steps of:
exposing a substrate using an exposure apparatus; and
developing the substrate that has been exposed,
wherein the exposure apparatus includes an illumination optical system that includes a barrel configured to house a lens having an optical axis that extends in a direction perpendicular to a gravity direction,
wherein the barrel includes an inner surface that has a pair of projections each contacting an outer circumference surface of the lens, and
wherein on a plane perpendicular to the optical axis, when viewed from an intersection between the optical axis and the plane perpendicular to the optical axis, an absolute value of an angular range in which each projection contacts the outer circumference surface of the lens is from 5° to 40° with respect to an axis that passes the intersection and is parallel to the gravity direction.
